(19) United States
(12) Patent Application Publication
(10) Pub. No.: US 2003/0073469 A1
(43) Pub. Date: Apr. 17, 2003

(54) Hands-free amplifier for mobile telephone

(76) Inventor: Parkson Wu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,144

(22) Filed: Jun. 14, 2002

(30) Foreign Application Priority Data
Oct. 12, 2001 (TW) 90217426

(51) Int. Cl. H04M 1/00

(52) U.S. Cl. 455/569; 455/557

(57) ABSTRACT

A hands-free amplifier for a hand-held communication device such as a mobile telephone or a personal digital assistant. The hands-free amplifier directly plugs into the hand-held communication device so that external wires are unnecessary. The amplifier includes a loudspeaker, a microphone, some control circuits and an internal battery pack. The incorporation of internal battery pack eliminates the need for electrical energy from an external power source.

### CROSS REFERENCE TO RELATED APPLICATIONS

This application claims the priority benefit of Taiwan application serial no. 90217426, filed Oct. 12, 2001.

### BACKGROUND OF INVENTION

1. Field of Invention

The present invention relates to a hands-free amplifier. More particularly, the present invention relates to a hands-free amplifier for a mobile telephone.

2. Description of Related Art

One major advancement as we step into the twenty-first century is a proliferation of digital communication. Through the international deregulation of cable and wireless communication, the standardization of communication protocols and the influx of private investment, information is shuttling around in a web of invisible links that traverse international boundaries. In fact, freedom in communication has lead to an increase in the nation's strength and social benefits for the community as a whole.

The advancement of personal communication and the development of wireless networks are largely triggered by the introduction of digital communication devices and manufacturing technology of semiconductor packages. Communication between people on the move is very much facilitated by such equipment. Starting from the mid-1990s, the rapid introduction of digital wireless equipment has lead to a tremendous change in our life style. The proliferation of the so-called information appliances such as devices having communication and networking capability has become the latest milestone after the computer and electronic industries. Aside from person-to-person communication, the latest applications supply information and entertainment features. According to this definition, information appliances are capable of real-time networking, carrying out voice communication, transmitting/receiving data, conducting network browsing and so on. Currently, information appliances that perform the above functions are mobile telephones, personal digital assistants (PDAs), notebook computers, and web pads.

Conventionally, to carry out a voice communication or to listen to music, the aforesaid hand-held communication devices often utilize a wire-up earphone or a hands-free receiver. However, a conventional hands-free receiver or earphone is connected to a mobile telephone through a piece of wire (such as a telephone wire) leading to great inconvenience. A receiver or an earphone having a wireless connection with the mobile phone at present is not only quite expensive, but also inconvenient and requires installation by professionals. In addition, most hands-free devices require amplification and hence energy has to be drawn from a convenient source such as a car battery. In brief, major drawbacks of most conventional hands-free system include wiring connection, package volume, and cost.

### SUMMARY OF INVENTION

Accordingly, one object of the present invention is to provide a hands-free amplifier for a hand-held communication device such as a mobile telephone or a personal digital assistant (PDA). The hands-free amplifier basically includes a loudspeaker, a microphone, and a battery pack. The amplifier requires no external power source and external wiring and hence is free from all the inconveniences in most conventional wire-up earphone or hands-free system. Moreover, production cost of the amplifier is low and the amplifier is easy to integrate with the communication device.

To achieve these and other advantages and in accordance with the purpose of the invention, as embodied and broadly described herein, the invention provides a hands-free amplifier for a hand-held communication device having a connector. The hands-free amplifier includes a main body, a substrate board, a voice amplifier, a voice receiver, and a battery pack. The substrate board is enclosed inside the main body and has a signal connector. The signal connector has an opening on the main body so that the signal connector may engage with the connector on the hand-held communication device. The voice amplifier having an electrical connection with the substrate board is installed within the main body. Similarly, the voice receiver having an electrical connection with the substrate board is also installed inside the main body. The battery pack having at least one battery is housed inside the main body. The battery pack and the substrate board are electrically connected. The battery pack provides all the necessary power to the substrate board.

One major aspect of this invention is the integration of a voice amplifier and a voice receiver to form a hands-free amplifier system having a terminal for engaging with the connector of a mobile telephone. Voice messages are broadcast through a loudspeaker and voice messages are received through a microphone within the amplifier so that the hands-free function of a mobile telephone is enhanced.

A second major aspect of this invention is the introduction of a built-in power source (a battery pack) into the hands-free amplifier so that portability is increased, production cost is reduced, and the installation of the amplifier is facilitated.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view of a hands-free amplifier and an associated hand-held mobile telephone according to one preferred embodiment of this invention; and

FIG. 2 is an explosive view of all the components constituting a hands-free amplifier according to this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

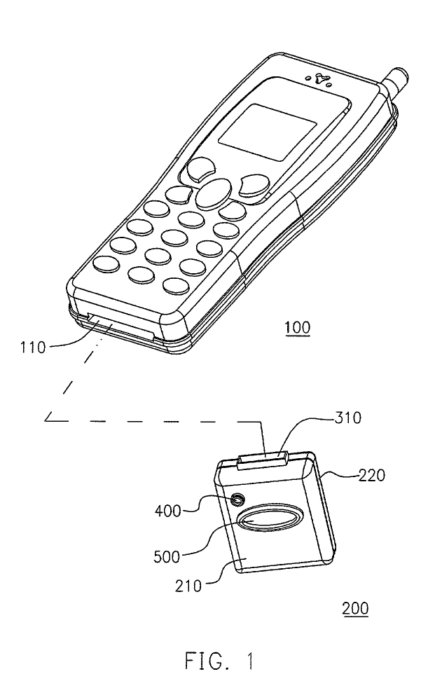

FIG. 1 is a perspective view of a hands-free amplifier and an associated hand-held mobile telephone according to one preferred embodiment of this invention. The main body of a hands-free amplifier 200 has a microphone 400 and a loudspeaker 500 opening on its front cover 210. To use the hands-free amplifier 200 of this invention, the signal connector 310 of the amplifier is plugged into the connector 110 of a mobile telephone 100. Through the hands-free amplifier, a voice communication with a third party on the other side of the line may be initiated.

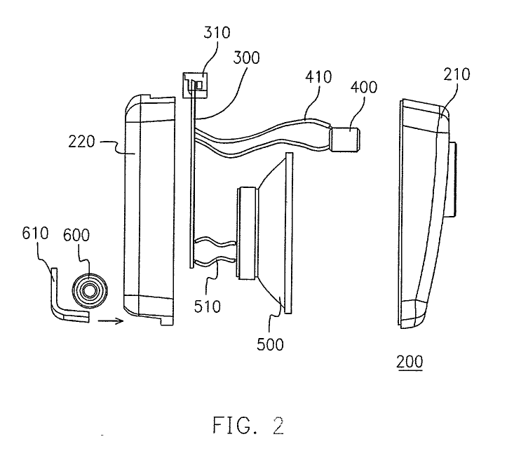

FIG. 2 is an explosive view of all the components constituting a hands-free amplifier according to this invention. The main body 200 comprises of a front cover 210 and a back cover 220. A substrate board 300, a microphone 400, a loudspeaker 500 and a battery pack 600 are housed inside the main body. A signal connector 310 is mounted on the substrate board 300. The signal connector 310 plugs into an external device through an opening on the main body 200 facing outside. A voice receiver such as a microphone 400 and a voice amplifier such as a loudspeaker system 500 are connected to the substrate board 300 via signaling cables 410 and 510 respectively. Through the voice controlling circuit on the substrate board 300, transmission/reception and amplification of voice data is controlled. The power source such as a battery pack 600 of the hands-free amplifier 200 is located somewhere near the bottom of the back cover 220. The battery pack provides the necessary power to the substrate board 300. When battery power is exhausted, battery may be replaced by opening up the backside cover 610.

The battery pack 600 can be a conventional replaceable dc battery or rechargeable battery such as nickel-hydride or lithium battery.

Due to a slight difference in connector 110 design for each mobile telephone manufacturer 100, the signal connector 310 may include specifications for matching with a variety of mobile telephones. An appropriate signal connector 310 may be selected to incorporate with the substrate board 300 during assembly.

In addition, the voice-receiving microphone 400 and the voice-amplifying loudspeaker 500 may be replaced by a system having both of these functions. For example, the receiver/amplifier system may be a loudspeaker with voice-receiving capability.

In conclusion, the major advantages of this invention includes:

1. A voice amplifier and voice receiver are integrated together to form a hands-free amplifier having a terminal for engaging with the external connector of a mobile telephone. Incoming voice is amplified through the loudspeaker and outgoing voice is received through the microphone and hence hands-free function of the mobile telephone is enhanced.

2. The hands-free amplifier has a built-in battery pack so that portability is increased, production cost is reduced, and installation of the amplifier is facilitated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A hands-free amplifier for a hand-held communication device having a connector thereon, the hands-free amplifier comprising of:
a main body;
a substrate board inside the main body, wherein the substrate board has a signal connector with an opening end on the main body suitable for engaging with a connector on a hand-held communication device;
a voice amplifier inside the main body, wherein the voice amplifier and the substrate board are electrically connected to transmit signals;
a voice receiver inside the main body, wherein the voice receiver and the substrate board are electrically connected to transmit signals; and
a power source electrically connected to the substrate board inside the main body to provide electrical power for driving the substrate board.

2. The hands-free amplifier of claim 1, wherein the voice amplifier includes a loudspeaker.

3. The hands-free amplifier of claim 1, wherein the voice receiver includes a microphone.

4. The hands-free amplifier of claim 1, wherein the power source includes a replaceable battery pack.

5. The hands-free amplifier of claim 1, wherein the power source includes a rechargeable battery pack.

6. The hands-free amplifier of claim 1, wherein the hand-held communication device includes a mobile telephone.

7. The hands-free amplifier of claim 1, wherein the substrate board further includes a voice control circuit for controlling the reception of the voice receiver and the transmission of the voice amplifier and adjusting voice volume.

8. The hands-free amplifier of claim 1, wherein the power source includes a battery pack having at least one battery.

9. A hands-free amplifier for a hand-held communication device having a connector thereon, the hands-free amplifier comprising of:
a main body;
a substrate board inside the main body, wherein the substrate board has a signal connector with an opening end on the main body suitable for engaging with a connector on a hand-held communication device;
a voice receiving/amplifying device having electrical signal connection with the substrate board inside the main body; and
a power source electrically connected to the substrate board inside the main body to provide electrical power for driving the substrate board.

10. The hands-free amplifier of claim 9, wherein the voice receiving/amplifying device includes a loudspeaker having both voice-amplifying and voice-receiving capabilities.

11. The hands-free amplifier of claim 9, wherein the power source includes a replaceable battery pack.

12. The hands-free amplifier of claim 9, wherein the power source includes a re-chargeable battery pack.

13. The hands-free amplifier of claim 9, wherein the hand-held communication device includes a mobile telephone.

14. The hands-free amplifier of claim 9, wherein the substrate board further includes a voice control circuit for controlling the reception of the voice receiver and the transmission of the voice amplifier and adjusting voice volume.

15. The hands-free amplifier of claim 9, wherein the power source includes a battery pack having at least one battery.
